(19) United States
(12) Patent Application Publication
(10) Pub. No.: US 2002/0069733 A1
(43) Pub. Date: Jun. 13, 2002

(54) Cutting device and methods of use

(76) Inventors: Kurt Allenberg, Woodbury, MN (US); Anthony J. Campagna, Roseville, MN (US); Jan Schuren, Linne (NL)

Correspondence Address: MUETING, RAASCH & GEBHARDT, P.A., P.O. BOX 581415, MINNEAPOLIS, MN, 55458, US

(21) Appl. No.: 09/734,227

(22) Filed: Dec. 11, 2000

(51) Int. Cl. B26D 3/00

(52) U.S. Cl. 83/13; 30/294; 30/314

(57) ABSTRACT

A cutting device for use with orthopedic support devices constructed of cured orthopedic support material is disclosed. The cutting device includes handles and a blade that offer the ability to cut through cured orthopedic support material. Methods of using the cutting device to remove orthopedic support devices are also disclosed.

### FIELD OF THE INVENTION

The present invention relates to the field of cutting devices used to remove articles from the human or animal body.

### BACKGROUND

Semi-rigid orthopedic support materials may be used in some situations to form support devices, e.g., casts, that provide stable, semi-rigid support to injured limbs, while allowing some degree of movement, and offering the ability to resume its original shape after deformation. These support devices may be contrasted with support devices formed using rigid orthopedic support materials that do not allow for any movement of an injured limb. Commercially available orthopedic support materials that meet this definition are, e.g., SOFTCAST (Minnesota Mining and Manufacturing Company, St. Paul, Minn.).

The semi-rigid orthopedic support material and support devices manufactured therefrom may be useful in a variety of orthopedic applications in both humans and animals, particularly as a semi-rigid support for sprains and minor fractures, or as a protective device to prevent injury. The support material may also be used as a secondary support after primary healing of a fracture has occurred. Other applications include cast bracing where immobilization of the fracture area is required, but movement in the proximate joint such as the elbow, knee, or ankle is desired.

Although semi-rigid orthopedic support materials offer many advantages, removal of a support device formed using the material is typically accomplished by cutting with scissors or by unwrapping. Alternatively, the support devices may be removed using a cast saw.

These removal techniques offer a number of disadvantages. Cutting the semi-rigid orthopedic support materials with scissors may be difficult or impossible in some locations on a body, e.g., at the juncture along the front of foot and the lower leg or at other locations where it is difficult or impossible to manipulate scissors.

Unwrapping the support device may also have disadvantages, including, e.g., the additional time required to unwrap the resin-impregnated tape. Furthermore, support device removal by unwrapping results in destruction of the support device. That destruction may be problematic where the support device is being removed to, e.g., change dressings or perform some other task after which the support device needs to be replaced.

The use of a cast saw to remove support devices manufactured from semi-rigid orthopedic support materials is disadvantageous in that the saw must be used by a skilled operator for safety reasons. As a result, the cost to remove the support device may be increased.

Some devices have been developed to assist in the removal of bandages or clothing. None of these devices are, however, designed to remove semi-rigid orthopedic support materials. U.S. Pat. No. 5,341,822 (Farr et al.) discloses a bandage cutting device that relies on pushing a blade through the bandaging material, resulting in an elongated device unsuitable for use in tight corners. U.S. Pat. No. 5,590,471 (Wiezenthal) discloses a device similar to a letter opener that includes a blade that is pushed through bandaging material during use. U.S. Pat. No. 6,108,913 (Tidwell) discloses a device that operates with a scissoring action to cut through bandaging material or clothing.

### SUMMARY OF THE INVENTION

The present invention provides a cutting device for use with orthopedic support devices constructed of cured orthopedic support material. The present invention also provides methods of using the cutting device to remove orthopedic support devices. The cutting device includes handles and a blade that offer the ability to cut through cured orthopedic support material.

Among the advantages provided by the present invention are the ability to cut through the cured orthopedic support material by pulling the blade using the handles. The cutting is performed as the blade slices through the cured orthopedic support material without requiring a scissoring action. As a result, the cutting devices of the present invention may be well-suited for manipulation in areas that may be inaccessible or difficult to reach with conventional cutting devices, such as scissors.

In some embodiments, the blade may have a curved or arcuate cutting edge to reduce or eliminate the potential for binding of the material being cut. In other embodiments, the positions of the handles may be adjustable as desired by the user.

In one aspect, the present invention provides a cutting device that includes a blade having a cutting edge exposed in a first direction, the cutting edge defining a cutting plane; a body supporting the blade, the body defining a slot in which the cutting edge is exposed, the slot including an upper wall and a lower wall, wherein the lower wall and a bottom of the body define a foot; and a handle located in front of the cutting edge relative to the first direction, wherein the lower wall of the slot is further from the handle than the upper wall.

In another aspect, the present invention provides a method of cutting an orthopedic support device by providing a cutting device that includes a blade having a cutting edge exposed in a first direction, the cutting edge defining a cutting plane; a body supporting the blade, the body defining a slot in which the cutting edge is exposed, the slot including an upper wall and a lower wall, wherein the lower wall and a bottom of the body define a foot; and a handle located in front of the cutting edge relative to the first direction, wherein the lower wall of the slot is further from the handle than the upper wall. The method further includes locating at least one layer of cured orthopedic support material in the slot of the cutting device; and moving the cutting edge of the blade in the first direction, whereby the blade cuts through the cured orthopedic support material.

In another aspect, the present invention provides a method of removing an orthopedic support device from the lower leg and foot of a patient by providing a cutting device that includes a blade having a cutting edge exposed in a first direction, the cutting edge defining a cutting plane; a body supporting the blade, the body defining a slot in which the cutting edge is exposed, the slot including an upper wall and a lower wall, wherein the lower wall and a bottom of the body define a foot; and a handle located in front of the cutting edge relative to the first direction, wherein the lower wall of the slot is further from the handle than the upper wall. The method further includes inserting the foot of the cutting device between the patient and an orthopedic support device including cured orthopedic support material, whereby a portion of the cured orthopedic support material is located in the slot of the cutting device; and cutting the cured orthopedic support material by moving the cutting edge of the blade in the first direction.

These and other features and advantages of the devices and methods of the present invention may be discussed in more detail below in connection with various illustrative embodiments of the invention.

### BRIEF DESCRIPTION OF THE DRAWINGS

FIG. 1 is a side view of one cutting device according to the present invention.

FIG. 2 is a right side view of the cutting device of FIG. 1.

FIG. 3 is a plan view of another cutting device according to the present invention.

FIG. 4 illustrates use of a cutting device according to the present invention to remove an orthopedic support device from the lower leg and foot of a human patient.

### DETAILED DESCRIPTION OF ILLUSTRATIVE EMBODIMENTS OF THE INVENTION

Although designed to assist in the removal of support devices constructed of cured orthopedic support materials, the cutting devices of the present invention may find many other uses, such as the removal of bandaging materials, clothing, etc.

As used herein the term “cured orthopedic support material” is used to encompass any material used to form orthopedic support structures that includes a cured resin-impregnated carrier. By “cured,” it is meant that the material includes a resin with a reactive system that irreversibly solidifies upon the application of heat and/or other sources of energy, such as E-beam, ultraviolet, visible, etc., or with time upon the addition of a chemical catalyst, moisture, and the like. The irreversible solidification may involve polymerization, crosslinking, or both.

It may be preferred that the cured orthopedic support material include the combination of a moisture-cured resin impregnated in a supporting layer. Examples of cured orthopedic support materials that include a moisture-curable resin and a support layer are described in, e.g., U.S. Pat. No. 4,968,542 (Gasper et al.) and U.S. Pat. No. 5,007,418 (Bartizal et al.). It may be preferred that the supporting layer includes a textile (where the term “textile” includes one or more layers of a knit, woven, and/or nonwoven fabric).

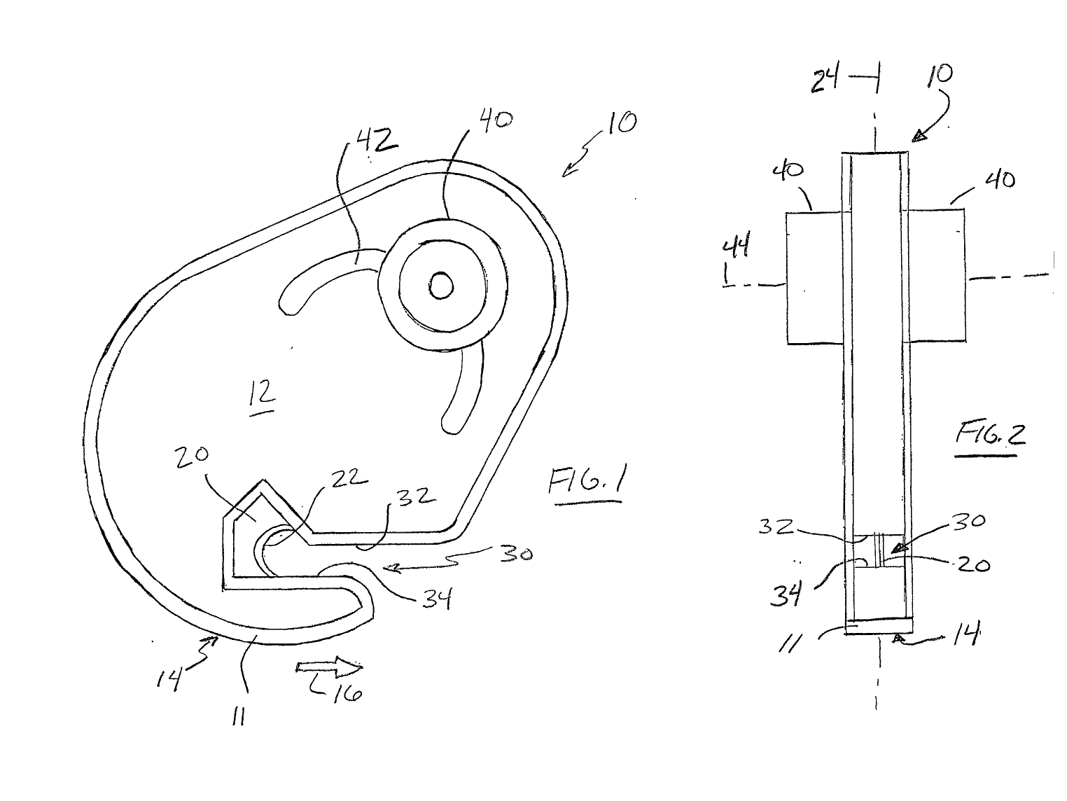

FIGS. 1 and 2 depict one illustrative embodiment of a cutting device according to the present invention. The cutting device 10 includes a body 12 that supports a cutting blade 20 and a pair of handles 40 for use in manipulating the cutting device 10. The blade 20 includes a cutting edge 22 that is exposed within a slot 30. The body 12 of the cutting device 10 includes a bottom foot 14 located on the opposite side of the slot 30 from the handles 40. The cutting edge 22 of blade 20 preferably lies within a cutting plane 24 (see FIG. 2).

The cutting edge 22 of blade 20 is depicted as being arcuately shaped. Where the cutting edge 22 of blade 20 is curved or arcuately shaped as depicted in FIG. 1, the cured material that is being cut by the cutting device 10 may exhibit a reduced tendency to bunch up within the slot 30 during use of the cutting device 10. It may further be preferred that the arcuately shaped cutting edge 22 be provided as a circular arc. The blade 20 may be manufactured of any suitable material such as, e.g., stainless-steel.

The blade 20 and its cutting edge 22 are exposed within a slot 30 formed in the body 12 of the cutting device 10. The cutting edge 22 of blade 20 is exposed within the slot 30 along a first direction 16, which is also the direction in which the cutting device 10 is moved during use. The slot 30 includes an upper wall 32 and a lower wall 34 wherein the upper wall 32 is preferably located closer or more proximate to the handles 40 while the lower wall 34 is located closer or proximate to the foot 14 of the cutting device 10. The size of the slot 30 may vary depending on the intended application, although it is preferred that the size of the slot 30 be sufficiently small to prevent (or at least reduce the likelihood of) accidental injury on the exposed cutting edge 22 of blade 20.

It may be preferred that the lower wall 34 of the slot 30 be shorter along the first direction 16 than the upper wall 32. As result, the foot 14 is located behind the forwardmost portion of the upper wall 32 as the cutting device 10 is moved in the direction 16. This arrangement may be particularly helpful in maneuvering the cutting device 10 around tortuous curves which may be found in various parts of a human and/or animal anatomy (e.g., the junction between the lower human leg and the top of the foot).

The body 12 of the cutting device 10 may also preferably include a flange 11 that extends about the edges of the body 12 and is widened as compared to the body 12, e.g., where the body 12 and flange 11 form a portion of an I-beam construction. The use of a flange 11 may provide a number of advantages such as increased rigidity of the body 12, as well as increased stability of the cutting device 10 during use.

The flange 11 may vary in width around the body 12. For example, the flange 11 may be wider in the area along the foot 14 of the body 12 to provide a more stable base of support for the cutting device 10. Further, it may be desirable to provide a narrower flange (or no flange at all) directly behind the blade 20 and along the back of the cutting device 10 and, i.e., behind the slot 30, to reduce the likelihood of catching the material being cut on the flange.

It may also be desirable to provide a wider flange 11 along the upper wall 32 of the slot 30 to protect the user's knuckles from abrasion during use. It may, for example, be preferred that the flanges 11 on each side of the body 12 extend outward by a distance that is approximately equal to the width of an adult human finger.

The cutting device 10 also includes a pair of handles 40 for use in manipulating the cutting device 10 during use. In the embodiment depicted in FIGS. 1 and 2, the handles 40 are mounted within a handle aperture 42 formed in the body 12 of the cutting device 10. Although the illustrated handles 40 are depicted as being aligned along an axis 44, the handles 40 may, instead, be offset with respect to each other on opposite sides of the body 12.

The handles 40 may be connected to the cutting device 10 by any suitable technique or mechanism. For example, the handles 40 may be connected to each other through handle aperture 42 by a threaded connection, a snaplock connection, etc.

Furthermore, the handles 40 may be stationary with respect to the body 12 or they may be mounted for free-floating movement within the handle aperture 42 as desired. A fixed, stationary connection may be preferred to assist with manipulation of the cutting device 10.

The size of the handles 40 may vary depending on the intended application of the cutting device 10. It may, however, be preferred that each of the handles 40 extend outward from the cutting device 10 by a distance that is approximately equal to the width of an adult human finger. As a result, the cutting device 10 may be pulled through the material to be cut when the user places a finger around each of the handles 40.

The body 12 of the cutting device 10 may be manufactured by any suitable technique. For example, it may be desirable to manufacture the body 12 of a molded polymeric material that is sufficiently inexpensive to allow for disposal of the cutting device 10 after a single use. In other instances, the body 12 may be manufactured of more durable materials, such that the cutting device 10 may be reused numerous times. In some instances, it may be desirable to manufacture the body 12 in two halves that can be separated to allow for removal and replacement of the blade 20 when the cutting edge 22 becomes dulled or worn.

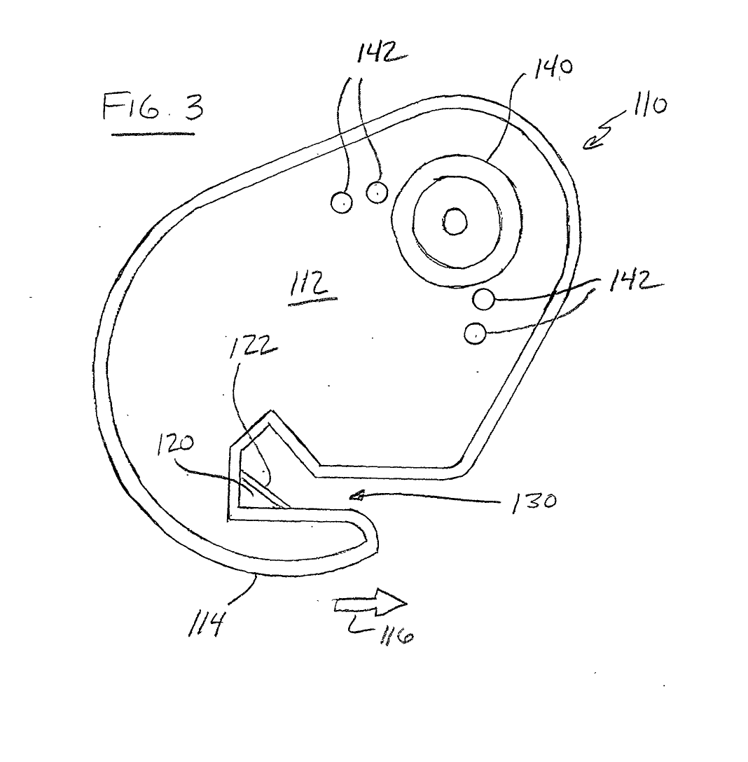

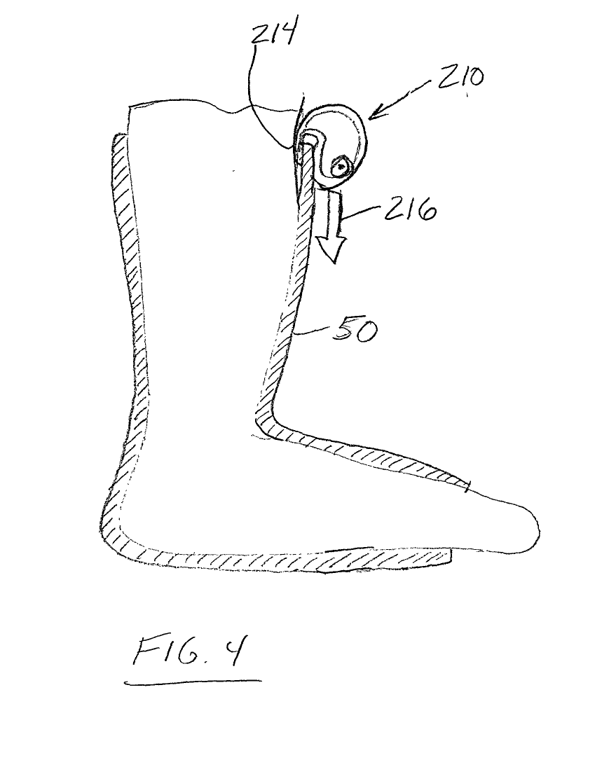

FIG. 3 depicts another embodiment of a cutting device 110 according to the present invention. In many respects, the cutting device 110 is similar to the cutting device 10 of FIGS. 1 and 2. It includes a body 112, a cutting blade 120 with a cutting edge 122 exposed within a slot 130. It also includes a foot 114 and handles 140. Furthermore, the cutting device 110 is designed to be pulled in a first direction 116 during use.

Among the differences between the cutting device 110 and the cutting device 10, are the blade 120, which includes a straight cutting edge 122 that is exposed along the first direction 116. Another difference between the cutting device 110 and cutting device 10 is in the connection of the handles 140 to the body 112. The body 112 includes a plurality of handle apertures 142 in which handles 140 may be located. As a result, the user may adjust the position of the handles 140 relative to the blade 120.

Although the position of the handles 40, 140 may be adjusted in the cutting devices 10, 110 described above, it should be noted that the handles are always located ahead of the cutting edge 22, 122 exposed within slot 30, 130. That arrangement is required to allow the cutting device to be pulled using the handles.

FIG. 4 illustrates one method in which a cutting device 210 of the present invention may be used to remove an orthopedic support device 50 made of cured orthopedic support material. The support device 50 is located about the lower leg and foot of a human patient, similar to a boot. In some instances, a support device in this form may be used as a total contact cast for the treatment of plantar ulcers. See, e.g., Myerson et al., “The Total-Contact Cast for Management of Neuropathic Plantar Ulceration of the Foot,” The Journal of Bone and Joint Surgery, Incorporated, Vol. 74-A(2), pp. 261-69 (February, 1992).

The cutting device 210 is employed by inserting the foot 214 of the cutting device 210 between the patient and the support device 50, whereby a portion of the support device 50 is located in the slot of the cutting device 210. The support device 50 is then cut open by pulling the cutting device 210 in the first direction 216. The support device 50 may be cut open using an anterior (as seen in FIG. 4) or posterior cut. The cutting direction may be in either the distal direction (as seen in FIG. 4) or the proximal direction, at the discretion of the user.

One advantage of the cutting devices of the present invention is in the ability to perform an anterior cut of the boot-like support device 50. Such cuts are difficult or impossible to make using conventional cutting devices such as scissors. The anterior cut does, however, provide for reuse of the support device 50 without significantly degrading the support it offers.

All references and publications cited herein are expressly incorporated herein by reference in their entirety into this disclosure. Illustrative embodiments of this invention are discussed and reference has been made to possible variations within the scope of this invention. These and other variations and modifications in the invention will be apparent to those skilled in the art without departing from the scope of this invention, and it should be understood that this invention is not limited to the illustrative embodiments set forth herein. Accordingly, the invention is to be limited only by the claims provided below.

What is claimed is:

1. A cutting device comprising:
a blade comprising a cutting edge exposed in a first direction, the cutting edge defining a cutting plane;
a body supporting the blade, the body defining a slot in which the cutting edge is exposed, the slot comprising an upper wall and a lower wall, wherein the lower wall and a bottom of the body define a foot; and
a handle located in front of the cutting edge relative to the first direction, wherein the lower wall of the slot is further from the handle than the upper wall.

2. The device of claim 1, wherein the handle extends transverse to the cutting plane.

3. The device of claim 1, wherein the handle comprises a pair of handles extending outward from the body.

4. The device of claim 3, wherein the body comprises a handle aperture formed therethrough, and further wherein the pair of handles connect to each other through the handle aperture.

5. The device of claim 4, wherein the handle aperture is elongated.

6. The device of claim 4, wherein the handle aperture is arcuately shaped.

7. The device of claim 3, wherein the body comprises a plurality of handle apertures formed therethrough, and further wherein each of the pair of handles is attached to the body at one of the handle apertures.

8. The device of claim 3, wherein each handle of the pair of handles extends outward from the body by a finger width.

9. The device of claim 1, wherein the lower wall of the slot is shorter along the first direction than the upper wall of the slot.

10. The device of claim 1, wherein the exposed cutting edge comprises an arc.

11. The device of claim 1, wherein the exposed cutting edge comprises a circular arc.

12. A method of cutting an orthopedic support device comprising:
providing a cutting device comprising:
a blade comprising a cutting edge exposed in a first direction, the cutting edge defining a cutting plane;
a body supporting the blade, the body defining a slot in which the cutting edge is exposed, the slot comprising an upper wall and a lower wall, wherein the lower wall and a bottom of the body define a foot; and
a handle located in front of the cutting edge relative to the first direction, wherein the lower wall of the slot is further from the handle than the upper wall;
locating at least one layer of cured orthopedic support material in the slot of the cutting device; and
moving the cutting edge of the blade in the first direction, whereby the blade cuts through the cured orthopedic support material.

13. The method of claim 12, wherein the moving comprises pulling the handle of the cutting device in the first direction.

14. The method of claim 12, further comprising adjusting the position of the handle relative to the blade.

15. The method of claim 12, wherein the handle comprises a pair of handles extending outward from the body.

16. The method of claim 12, wherein the exposed cutting edge comprises an arc.

17. The method of claim 12, wherein the exposed cutting edge comprises a circular arc.

18. A method of removing an orthopedic support device from the lower leg and foot of a patient, the method comprising:
providing a cutting device comprising:
a blade comprising a cutting edge exposed in a first direction, the cutting edge defining a cutting plane;
a body supporting the blade, the body defining a slot in which the cutting edge is exposed, the slot comprising an upper wall and a lower wall, wherein the lower wall and a bottom of the body define a foot; and
a handle located in front of the cutting edge relative to the first direction, wherein the lower wall of the slot is further from the handle than the upper wall;
inserting the foot of the cutting device between the patient and an orthopedic support device comprising cured orthopedic support material, whereby a portion of the cured orthopedic support material is located in the slot of the cutting device; and
cutting the cured orthopedic support material by moving the cutting edge of the blade in the first direction.

19. The method of claim 18, wherein the foot of the cutting device is inserted between the patient and the support device proximate the anterior surface of the foot or the shin.

20. The method of claim 18, wherein the cutting comprises cutting the support device along the anterior surface of the shin and the foot.
